(19) United States
(12) Patent Application Publication
(10) Pub. No.: US 2006/0007601 A1
(43) Pub. Date: Jan. 12, 2006

(54) Base plate and hard disk drive provided therewith

(75) Inventor: Kyoung-man Cho, Seoul (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., LTD, Suwon-si (KR)

(21) Appl. No.: 11/142,491

(22) Filed: Jun. 2, 2005

(30) Foreign Application Priority Data
Jul. 7, 2004 (KR) 2004-52602

(51) Int. Cl. G11B 17/00; G11B 5/55

(52) U.S. Cl. 360/264.7; 360/97.01

(57) ABSTRACT

A base plate on which a disk is rotatably installable and an actuator which transfers data to and/or from the disk is pivotably installable, including a buffer slot formed around a pivot axis of the actuator to absorb at least some of a shock transmitted to the actuator.

### CROSS-REFERENCE TO RELATED APPLICATION

This application claims the priority of Korean Patent Application No. 2004-52602, filed on Jul. 7, 2004, in the Korean Intellectual Property Office, the disclosure of which is incorporated herein by reference.

### BACKGROUND OF THE INVENTION

1. Field of the Invention

The present invention relates to a hard disk drive (HDD), and more particularly, to a base plate that can absorb an external shock transmitted to an actuator, and an HDD containing the base plate.

2. Description of Related Art

FIG. 1 is an exploded perspective view of a conventional hard disk drive (HDD).

Referring to FIG. 1, an HDD 10 includes a base plate 11, a disk 25 which is a data recording medium, a spindle motor 30 which is installed on the base plate 11 and rotates the disk 25, magnetic heads 41a and 41b which record and/or reproduce data on/from the disk 25, an actuator 40 which includes means for moving the magnetic heads 41a and 41b, and a cover plate 20 which is attached to the base plate 11 and protects the disk 25, the spindle motor 30, and the actuator 40 on the base plate 11.

The disk 25 is fixedly installed on a rotor of the spindle motor 30 to rotate relative to the base plate 11. Servo signals indicating positions of data to be recorded on top and bottom surfaces of the disk 25 are previously recorded on tens of thousands of tracks formed along the circumference of the disk 25.

The actuator 40 has an insertion hole into which a protrusion 15 formed on the base plate 11 is inserted, such that the actuator 40 rotates about the protrusion 15 in response to a voice coil motor (VCM) 47. Further, the actuator 40 includes means for supporting the magnetic heads 41a and 41b. The magnetic head supporting means includes a swing arm 44 and suspensions 43a and 43b that are installed on the swing arm 44 and elastically bias sliders 42a and 42b on which the magnetic heads 41a and 41b are mounted toward the top and bottom surfaces of the disk 25.

In operation, when the HDD 10 is turned on and the disk 25 begins to rotate, a lifting force is generated due to air pressure and the sliders 42a and 42b are maintained over the surface of the disk 25 at a flying height at which the lifting force generated due to the rotation of the disk 25 is equal to an elastic force of the suspensions 43a and 43b. Accordingly, the magnetic heads 41a and 41b mounted on the sliders 42a and 42b record data on the disk 25 or reproduce data from the disk 25 while maintaining a specified distance from the rotating disk 25.

However, the above-described conventional HDD has a drawback. When the conventional HDD 10 is in operation, an external shock may be applied to the HDD 10. Since the sliders 42a and 42b on which the magnetic heads 41a and 41b are mounted fly over the surface of the disk 25 during the operation of the HDD 10, if an external shock is applied, the sliders 42a and 42b may collide with the disk 25, leading to a failure of the HDD 10. And, even when the sliders 42a and 42b do not collide with the disk 25, errors in data recording and reproducing operations may be caused. The external shock is transmitted to the actuator 40 via the base plate 11. The conventional base plate 11 has no means for absorbing the shock transmitted to the actuator 40.

### BRIEF SUMMARY

An embodiment of the present invention provides a base plate, which can absorb an external shock transmitted to an actuator, and a hard disk drive (HDD) provided with the base plate.

According to an aspect of the present invention, there is provided a base plate on which a disk is rotatably installable and an actuator which transfers data to and/or from the disk is pivotably installable, including a buffer slot formed around an axis to absorb at least some of a shock transmitted to the actuator.

The base plate may also include a pair of connecting portions crossing the buffer slot to connect an inner wall of the buffer slot to an outer wall of the buffer slot. The buffer slot may have a circular shape centered around the axis.

The plurality of buffer slots may have a concentric-circular shape, and a straight line between the axis and a pair of connecting portions of a buffer slot may not be the same as a straight line connecting the axis and a pair of connecting portions of another buffer slot.

The first buffer slot may be close to the axis and a second buffer slot may be farther from the axis than the first buffer slot. A straight line between the axis and a pair of connecting portions of the first buffer slot may intersect perpendicularly a straight line connecting between the axis and a pair of connecting portions of the second buffer slot.

According to another aspect of the present invention, there is provided a hard disk drive including: a base plate; and an actuator pivotably installed on the base plate, pivotable about an axis, and supporting on an end portion thereof of a slider on which a magnetic head for recording or reproducing data on a disk is mounted. The a buffer slot is formed around the axis on the base plate to absorb at least some of a shock transmitted to the actuator.

According to another aspect of the present invention, there is provided a base plate including: a pivot section to which an actuator is pivotably mountable; and a shock absorbing section which surrounds the pivot section and which includes first and second respective buffer slots, a pair of first connecting portions, and a pair of second connecting portions, the first and second respective buffer slots absorbing at least some of a shock transmitted to the actuator, the first and second connecting portions partially connecting the protrusion to the base plate.

According to another aspect of the present invention, there is provided a method of preventing disk failure, including: connecting a pivot protrusion to which an actuator is pivotably mountable to a base plate through plural connecting portions; substantially isolating the pivot protrusion via plural buffer slots between the plural connection portions; and attenuating a shock by absorbing at least some of the shock via the first and second buffer slots and indirectly transmitting the shock to the pivot protrusion through the first and second connecting portions.

Additional and/or other aspects and advantages of the present invention will be set forth in part in the description which follows and, in part, will be obvious from the description, or may be learned by practice of the invention.

### BRIEF DESCRIPTION OF THE DRAWINGS

These and/or other aspects and advantages of the present invention will become apparent and more readily appreciated from the following detailed description, taken in conjunction with the accompanying drawings of which:

FIG. 1 is an exploded perspective view of a conventional hard disk drive (HDD);

FIG. 2 is an exploded perspective view of an HDD according to an embodiment of the present invention;

FIG. 3 is a plan view of a base plate according to the embodiment of FIG. 2; and

FIGS. 4 and 5 are simulation graphs illustrating impulse responses when a virtual impulse is input to a conventional base plate and the base plate according to the embodiment of FIG. 2, FIG. 4 illustrating an impulse response in an X-direction, FIG. 5 illustrating an impulse response in a Y-direction.

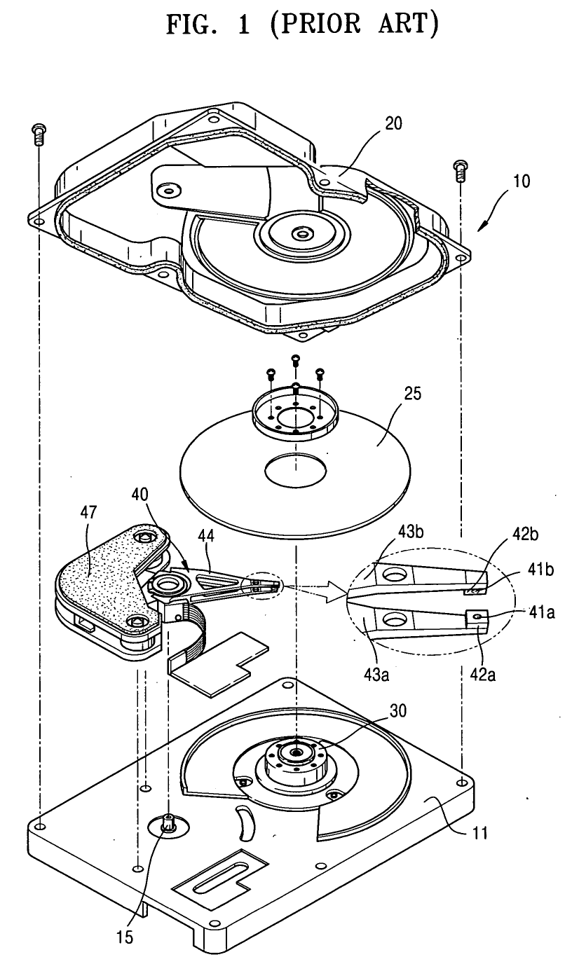

### DETAILED DESCRIPTION OF EMBODIMENT

Reference will now be made in detail to an embodiment of the present invention, examples of which are illustrated in the accompanying drawings, wherein like reference numerals refer to the like elements throughout. The embodiment is described below in order to explain the present invention by referring to the figures.

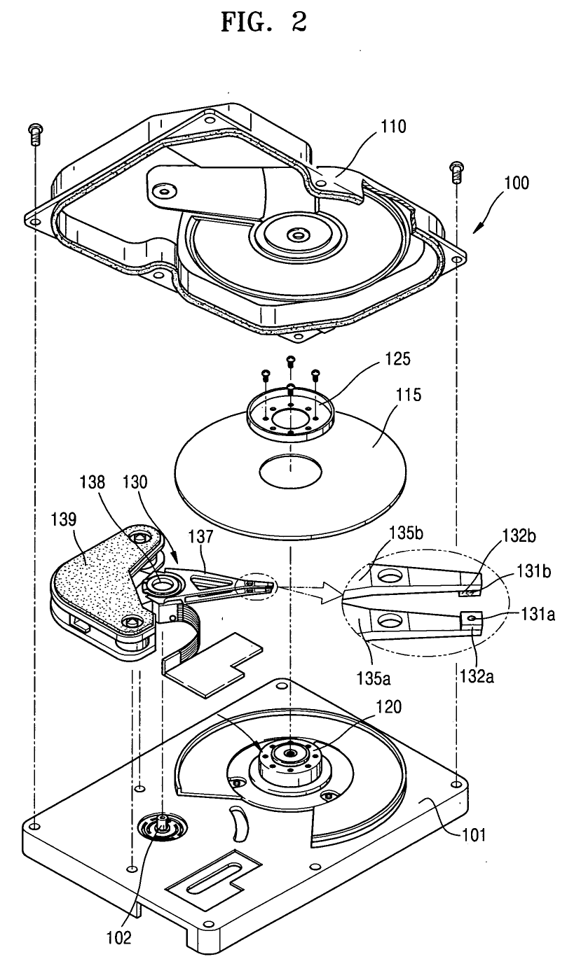

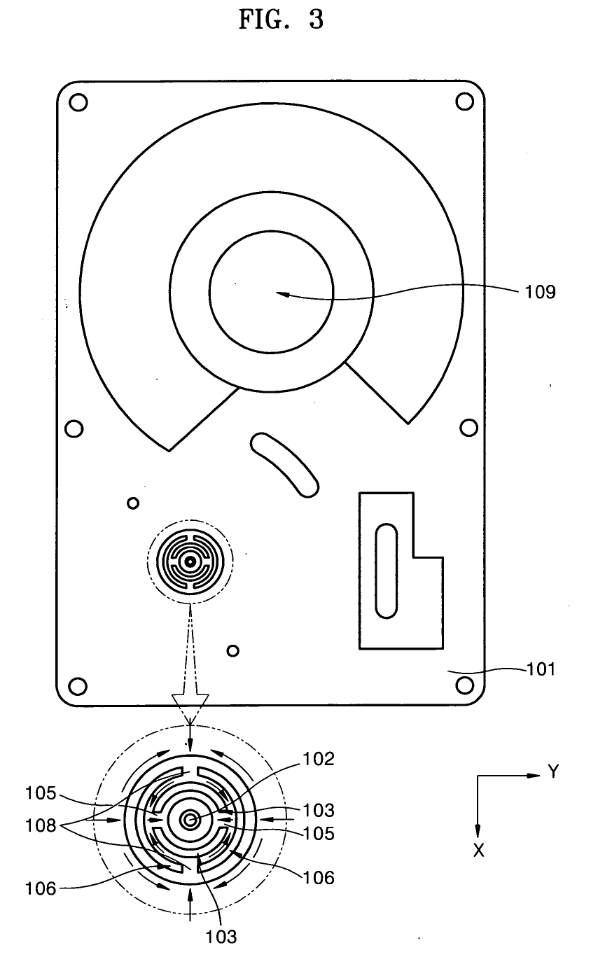

FIG. 2 is an exploded perspective view of a hard disk drive (HDD) according to an embodiment of the present invention, and FIG. 3 is a plan view of a base plate according to an embodiment of the present invention.

Referring to FIGS. 2 and 3, an HDD 100 includes a housing that is formed by attaching a cover plate 110 to a base plate 101 leaving a specified inner space therebetween. A disk 115, a spindle motor 120, and an actuator 130 are installed in the housing.

The housing includes the base plate 101, which supports the spindle motor 120 and the actuator 130, and the cover plate 110, which is attached to the base plate 101 and protects the disk 115. The housing may be made of stainless steel or aluminium.

The disk 115 is mounted inside the housing. Four or more disks may be mounted in an HDD to increase data storage capacity.

The spindle motor 120 rotates the disk 115, and is fixedly inserted into a receiving hole 109 formed in the base plate 101. A disk clamp 125 is screwed to a top portion of the spindle motor 120 to prevent the disk 115 from separating.

The actuator 130 is used for recording data on the disk 115 or reading out data recorded on the disk 115, and is pivotably coupled to a protrusion 102 formed on the base plate 101. The actuator 130 includes a pivot bearing 138 into which the protrusion 102 is inserted, a swing arm 137, which rotates about the protrusion 102, first and second respective suspensions 135a and 135b coupled to a leading end of the swing arm 137, and first and second respective sliders 132a and 132b, which are respectively supported by the respective suspensions 135a and 135b. Respective first and second magnetic heads 131a and 131b for recording and reproducing data are mounted on the sliders 132a and 132b, respectively. Further, a voice coil motor (VCM) 139 provides a force for rotating the swing arm 137 about the protrusion 102. The VCM 139 is controlled by a servo control system, and rotates the swing arm 137 in a direction according to Fleming's Left Hand Rule due to an interaction between current input to a VCM coil and a magnetic field formed by magnets. Accordingly, the sliders 132a and 132b attached to leading ends of the respective suspensions 135a and 135b are moved over the disk 115 toward the spindle motor 120 or an outer periphery of the disk 115.

First and second respective buffer slots 103 and 106 are formed around the protrusion 102, which is formed on the base plate 101 and functions as a pivot axis of the actuator 130, so as to absorb a shock transmitted to the actuator 130. The first and second respective buffer slots 103 and 106 have a concentric-circular shape and are centered around the protrusion 102. The first slot 103 is closer to the protrusion 102 than the second buffer slot 106. If the width of the respective buffer slots 103 and 106 is too small, they cannot absorb a shock satisfactorily, and the width of the respective buffer slots 103 and 106 cannot be too large because of structural limitations. Accordingly, the width of the buffer slots 103 and 106 may range from 0.5 to 2.5 mm.

A pair of first connecting portions 105 cross the first buffer slot 103 to connect an inner wall of the first buffer slot 103 to an outer wall of the first buffer slot 103. Further, a pair of second connecting portions 108 cross the second buffer slot 106 to connect an inner wall of the second buffer slot 106 to an outer wall of the second buffer slot 106. The first and second connecting portions 105 and 108 partially connect the protrusion 102 to the base plate 101. However, a width of the respective connecting portions 105 and 108 may be as small as possible since an external shock is transmitted via the connecting portions 105 and 108.

The pair of first connecting portions 105 are symmetric with respect to the protrusion 102 on a straight line through the protrusion 102 in a direction Y. The pair of second connecting portions 108 are symmetric with respect to the protrusion 102 on a straight line through the protrusion 102 in a direction X. Consequently, the straight line connecting between the protrusion 102 and the pair of first connecting portions 105 intersects perpendicularly the straight line connecting between the protrusion 102 and the pair of second connecting portions 108.

The protrusion 102 is substantially isolated from the base plate 101 due to the respective first and second buffer slots 103 and 106, and is restrictively connected to the base plate 101 through the first and second connecting portions 105 and 108. Accordingly, if an external shock is applied to the HDD 100, part of the shock is absorbed by the first and second buffer slots 103 and 106, and as shown by arrows in FIG. 3, the external shock cannot directly reach the protrusion 102 but must be indirectly transmitted to the protrusion 102 through the first and second connecting portions 105 and 108. Thus, the shock is attenuated. As a result, an attenuated shock is transmitted to the actuator 103 as compared with a conventional HDD.

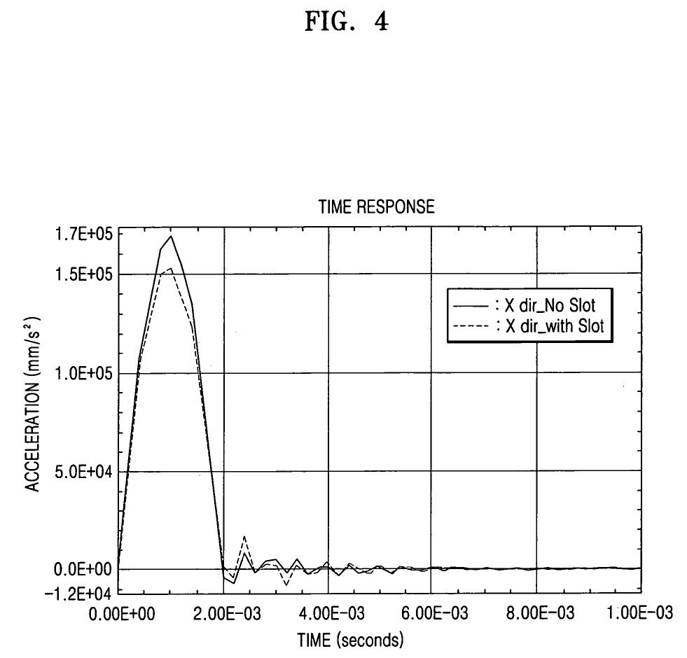

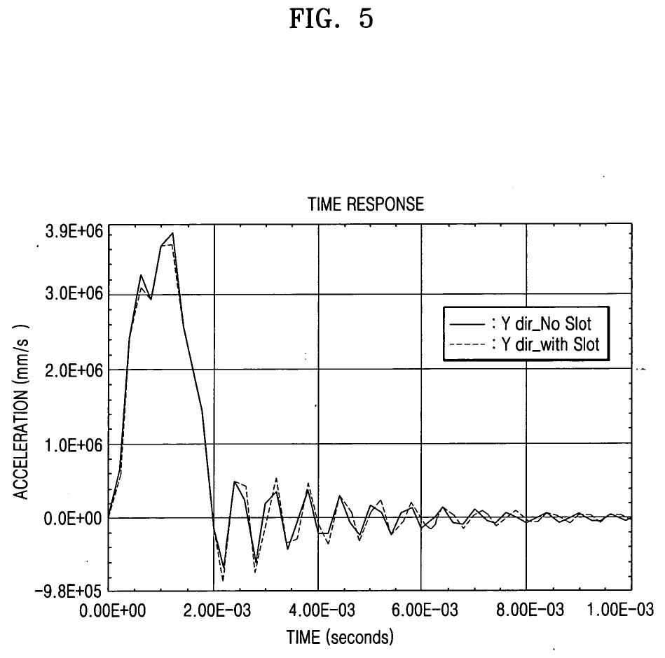

For the purpose of verifying the effects of the described embodiment of the present invention, a computer simulation was performed to compare an impulse response of a conventional base plate with an impulse response of the base plate according to the present invention. In detail, a virtual impulse was applied both to the conventional base plate without buffer slots and to the base plate with the first and second buffer slots according to the present invention as shown in FIG. 3. Impulse responses of the two base plates at the protrusion were calculated and graphed. The impulse, which is a half-sine wave signal with a peak value of 350 G (1 G=approximately 9800 mm/s²), was applied in a Y-direction (see FIG. 3) during 2 ms. FIGS. 4 and 5 are graphs illustrating impulse responses obtained through the computer simulation. Especially, FIG. 4 illustrates an impulse response in an X-direction, and FIG. 5 illustrates an impulse response in a Y-direction.

Referring to FIG. 4, the impulse response of the conventional base plate is shown as a solid line and has a peak value of 16.9 G. The impulse response of the base plate with the first and second buffer slots according to the present invention is shown as a dotted line and has a peak value of 15.3 G. Referring to FIG. 5, the impulse response of the conventional base plate is shown in a solid line and has a peak value of 392 G, and the impulse response of the base plate with the first and second buffer slots according to the present invention is shown as a dotted line and has a peak value of 366 G.

The base plate and the HDD provided with the base plate according to the disclosed embodiment of the present invention can absorb an external shock applied to the HDD more effectively than the conventional art, and accordingly, a weaker shock is transmitted to the actuator. As a result, the risk of failure due to a collision between the slider and the disk is reduced and the possibility of recording and reproducing errors is also reduced.

Although an embodiment of the present invention have been shown and described, the present invention is not limited to the described embodiment. Instead, it would be appreciated by those skilled in the art that changes may be made to the embodiment without departing from the principles and spirit of the invention, the scope of which is defined by the claims and their equivalents.

What is claimed is:

1. A base plate on which a disk is rotatably installable and an actuator which transfers data to and/or from the disk is pivotably installable, comprising:
a buffer slot formed around an axis to absorb at least some of a shock transmitted to the actuator.

2. The base plate of claim 1, further comprising a pair of connecting portions crossing the buffer slot to connect an inner wall of the buffer slot to an outer wall of the buffer slot,
wherein the buffer slot has a circular shape centered around the axis.

3. The base plate of claim 2, wherein a plurality of buffer slots have a concentric-circular shape, and a straight line between the axis and a pair of connecting portions of a buffer slot is not the same as a straight line connecting the axis and a pair of connecting portions of another buffer slot.

4. The base plate of claim 3, wherein the buffer slot includes a first buffer slot close to the axis and a second buffer slot farther from the axis than the first buffer slot,
wherein a straight line between the axis and a pair of connecting portions of the first buffer slot intersects perpendicularly a straight line connecting between the axis and a pair of connecting portions of the second buffer slot.

5. A hard disk drive comprising:
a base plate; and
an actuator pivotably installed on the base plate, pivotable about an axis, and supporting on an end portion thereof a slider on which a magnetic head for recording or reproducing data on a disk is mounted,
wherein a buffer slot is formed around the axis on the base plate to absorb at least some of a shock transmitted to the actuator.

6. The hard disk drive of claim 5, further comprising a pair of connecting portions crossing the buffer slot to connect an inner wall of the buffer slot to an outer wall of the buffer slot,
wherein the buffer slot has a circular shape centered around the axis.

7. The hard disk drive of claim 6, wherein a plurality of slots have a concentric-circular shape, and a straight line between the axis and a pair of connecting portions of a buffer slot is not the same as a straight line connecting the axis and a pair of connecting portions of another buffer slot.

8. The hard disk drive of claim 7, wherein the buffer slot includes a first buffer slot close to the axis and a second buffer slot farther from the axis than the first buffer slot,
wherein a straight line between the axis and a pair of connecting portions of the first buffer slot intersects perpendicularly a straight line connecting the axis and a pair of connecting portions of the second buffer slot.

9. A base plate comprising:
a pivot section to which an actuator is pivotably mountable; and
a shock absorbing section which surrounds the pivot section and which includes first and second respective buffer slots, a pair of first connecting portions, and a pair of second connecting portions, the first and second respective buffer slots absorbing at least some of a shock transmitted to the actuator, the first and second connecting portions partially connecting the protrusion to the base plate.

10. The base plate of claim 9, wherein the first and second buffer slots have a concentric-circular shape and are centered around the pivot section.

11. The base plate of claim 10, wherein the first slot is closer to the pivot section than the second buffer slot.

12. The base claim of claim 9, wherein the width of the buffer slots is between 0.5 to 2.5 mm.

13. The base plate of claim 9, wherein the pair of first connecting portions cross the first buffer slot to connect an inner wall of the first buffer slot to an outer wall of the first buffer slot.

14. The base plate of claim 9, wherein the pair of second connecting portions cross the second buffer slot to connect an inner wall of the second buffer slot to an outer wall of the second buffer slot.

15. The base plate of claim 9, wherein the pair of first connecting portions are symmetric with respect to the pivot section and on a straight line through the pivot section in a first direction, and wherein the pair of second connecting portions are symmetric with respect to the pivot section and on a straight line through the pivot section in a second direction perpendicular to the first direction.

16. A method of preventing disk failure, comprising:
connecting a pivot protrusion to which an actuator is pivotably mountable to a base plate through plural connecting portions;
substantially isolating the pivot protrusion via plural buffer slots between the plural connection portions; and
attenuating a shock by absorbing at least some of the shock via the first and second buffer slots and indirectly transmitting the shock to the pivot protrusion through the first and second connecting portions.
